(19) United States
(12) Patent Application Publication
(10) Pub. No.: US 2003/0065619 A1
(43) Pub. Date: Apr. 3, 2003

(54) Information processing device, information processing method, network system, security method for digital information, storage medium and program

(75) Inventor: Masaki Shitano, Tokyo (JP)

Correspondence Address: HOGAN & HARTSON L.L.P., 500 S. GRAND AVENUE, SUITE 1900, LOS ANGELES, CA, 90071-2611, US

(73) Assignee: CANON KABUSHIKI KAISHA

(21) Appl. No.: 10/254,738

(22) Filed: Sep. 25, 2002

(30) Foreign Application Priority Data
Sep. 28, 2001 (JP) 303869/2001
Sep. 28, 2001 (JP) 303817/2001
Aug. 23, 2002 (JP) 243441/2002

(51) Int. Cl. G06F 17/60

(52) U.S. Cl. 705/50

(57) ABSTRACT

An information processing device that can provide digital information that is unalterable, reliable and has high admissibility, while reducing processing burden on the user. The information processing apparatus is capable of exchanging digital information with an external device via a communication device. The information processing apparatus include an information obtaining module that obtains digital information, a certification obtaining module that requests a certification issuing authority that issues a digital certification for a given digital information to issue the digital certification, and obtains the digital certification via the communication device, and a storage control module that correlates the digital certification obtained to the digital information obtained by the information obtaining module and stores the digital certification in a storage medium.

### 1. FIELD OF THE INVENTION

The present invention relates to an information processing device, an information processing method, a network system, a security method for digital information, a computer-readable storage medium that stores a program that implements the above, and such program, that are used in editing devices for digital image data such as digital cameras, and that are used especially in devices or systems used to protect digital image data and to improve security.

### 2. DESCRIPTION OF RELATED ART

Conventionally, images (photographs) recorded in analog on camera film media have been used as admissible evidence in courts.

In the meantime, with advances in digital technology in recent years, computer equipment such as personal computers that can record digital images using digital cameras, for example, have come into wide use, and processing and editing of digital images have become easy as the performance of computer equipment has improved dramatically with the advance in digital technology.

However, due to the fact that digital images can be easily processed and edited as described above, phenomena different from facts can now be created in digital images. As a result, digital images have little to no admissibility as evidence in courts.

Consequently, in order to make digital images usable as evidence, some method must be used to realize a function that would prevent alterations of digital images, or, if a digital image has been altered, realize a function that can determine that an alteration has been made.

One method to solve the above problem, for example, is a method that uses electronic watermark processing. The electronic watermark processing is a processing to embed copyright information as electronic watermark information in the target image in order to detect and block unauthorized copying or appropriation of the target image.

In the conventional configuration that uses the electronic watermark processing described above, a digital image obtained by a digital camera is taken into computer equipment and an electronic watermark processing is executed inside the computer equipment.

In the meantime, according to a conventional configuration, instead of taking in a digital image obtained through a digital camera into a computer equipment, the equipment that obtained the digital image (e.g., digital camera) executes the electronic watermark processing when the digital image is obtained, and the information that is embedded as the electronic watermark is the name of the expected user specified in the production process or selling process and a symbol unique to the equipment.

However, in the conventional configuration, it is impossible to specify the name of the expected user during the production process. Furthermore, there is low reliability in reflecting information unique to the person who is the expected user during the selling process without any falsification. Moreover, since the electronic watermark information can be easily altered, the reliability of the digital image to which the electronic watermark information has been attached is low.

Consequently, the conventional configuration allows digital images to be easily altered, so that even if unauthorized alterations are prevented by embedding electronic watermark information there is low reliability in the information embedded as the electronic watermark information. As a result, the conventional configuration could not solve the problem of low to no admissibility of digital images.

Moreover, according to the conventional configuration, the processing to embed electronic watermark information into digital images was complicated and caused a great burden on the user. In addition, there were no services that could easily realize such complicated processing in place of the user or systems that provided such services.

### SUMMARY OF THE INVENTION

In view of the above, the present invention is to eliminate one or more of the shortcomings described above.

Additionally, the present invention provides an information processing device, a network system, a security method for digital information, a computer-readable storage medium that stores a program that implements the above, and such program, that can provide digital information that is unalterable, reliable and has high admissibility, while reducing processing burden on the user.

Therefore, an embodiment of the present invention pertains to an information processing apparatus that exchanges digital information with an external device via a communication device, the information processing apparatus comprising: an information obtaining module that obtains digital information; a certification obtaining module that requests a certification issuing authority that issues a digital certification for a given digital information to issue the digital certification, and obtains the digital certification via the communication device; and a storage control module that correlates the digital certification obtained to the digital information obtained by the information obtaining module and stores the digital certification in a storage medium.

The present invention also provides a favorable mechanism for providing services that are in accord with the purposes described above.

In this respect, another embodiment of the present invention pertains to an information processing apparatus that exchanges digital information with an external device via a communication device, the information processing apparatus comprising: an obtaining module that requests a certification issuing authority that issues a digital certification for a given digital information through an agent organization that performs an obtaining process to obtain the digital certification as an agent to issue the digital certification, and obtains the digital certification via the communication device.

Other purposes and features of the present invention shall become clear in the description of embodiment and drawings below.

### BRIEF DESCRIPTION OF THE DRAWINGS

FIG. 1 shows a block diagram indicating the configuration of a system in accordance with a first embodiment of the present invention.

FIG. 2 shows a block diagram of the configuration of a digital camera in the system according to the first embodiment.

FIG. 3 shows a diagram illustrating the overall operations of the system according to the first embodiment.

FIG. 4 show a flowchart illustrating the operations of the digital camera according to the first embodiment.

FIG. 5 shows one example of the certificate request issued by the digital camera according to the first embodiment.

FIG. 6 shows one example of a digital certificate issued by a certification authority upon receiving the certificate request.

FIG. 7 shows a block diagram illustrating the configuration of a computer function used to read from a computer-readable storage medium a program and execute it in order to have a computer realize a function according to the first embodiment.

FIG. 8 shows a block diagram illustrating the configuration of a system in accordance with a second embodiment of the present invention.

FIG. 9 shows a block diagram of the configuration of a digital camera in the system according to the second embodiment.

FIG. 10 shows a diagram illustrating the overall operations of the system according to the second embodiment.

FIG. 11 shows a flowchart illustrating the operations (S1400-S1411) of the digital camera.

FIG. 12 shows a flowchart illustrating the operations (S1412-S1419) of the digital camera.

FIG. 13 shows a flowchart illustrating the operations (S1600-S1608) of the digital camera.

FIG. 14 shows a flowchart illustrating the operations (S1700-S1709) of a digital image security service center of the system.

FIG. 15 shows a flowchart illustrating the operations (S1710-S1720) of the digital image security service center of the system.

FIG. 16 shows one example of a certificate request issued by the digital image security center.

FIG. 17 shows one example of a digital certificate issued by a certification authority upon receiving the certificate request.

FIG. 18 shows a flowchart illustrating the operations (S1400-S1411, S1450) of a digital camera according to the third embodiment.

FIG. 19 shows a flowchart illustrating the operations (S1600-S1621) of the digital camera according to the third embodiment.

FIG. 20 shows a flowchart illustrating the operations (S1623-S1636, S1608) of the digital camera according to the third embodiment.

FIG. 21 shows a flowchart illustrating the operations (S1700-S1709, S1751) of a digital image security service center of the system in accordance with a third embodiment of the present invention.

FIG. 22 shows a flowchart illustrating the operations (S1710-S1720, S1751) of the digital image security service center of the system according to the third embodiment.

FIG. 23 shows a block diagram indicating the configuration of a computer function used to read from a computer-readable storage medium a program and execute it in order to have a computer realize functions according to the second and third embodiments.

### DETAILED DESCRIPTION OF PREFERRED EMBODIMENTS

(First Embodiment)

Below, an embodiment of the present invention will be described with reference to the accompanying drawings.

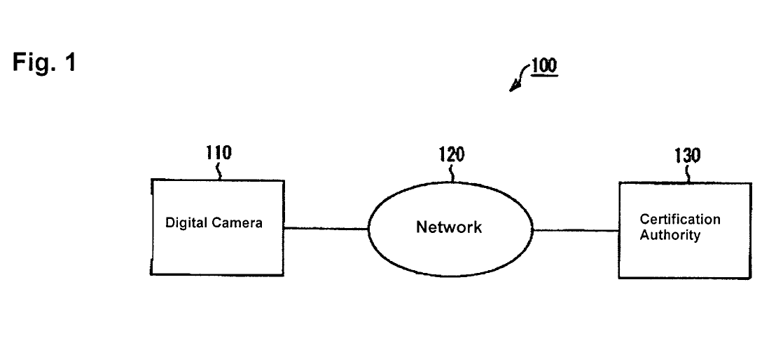

The present invention can be applied to a system 100 indicated in FIG. 1, for example. In the system 100 according to the present embodiment, a certification authority 130 (a reliable, public, third party organization) that is accessible via a network 120 from a digital camera 110 issues a digital certificate in response to a request from the digital camera 110; and the digital camera 110 upon receiving the digital certificate embeds in a photographed image (a digital image) the digital certificate as electronic watermark information; and the certification authority 130 encrypts the digital certificate according to the public key method and transfers it via the network 120. The system 100 according to the present embodiment has a configuration that makes the highly reliable digital certificate managed by the certification authority 130 usable as electronic watermark information, which makes it possible to provide digital images that are unalterable, reliable and have high admissibility.

Below, the configuration and operations of the system 100 according to the present embodiment will be describe in detail.

<Overall Configuration of the System 100>

As shown in FIG. 1, the system 100 has a configuration in which the digital camera 110 and the certification authority 130 are communicatively connected each other via the network 120.

To simplify the description, FIG. 1 shows one each of the digital camera 110 and the certification authority 130 connected to the network 120, but the number of these elements connected is not limited to one each.

The details of the digital camera 110 will be described in greater detail later, but the digital camera 110 has, in addition to basic functions of a camera, a function to attach electronic watermark information to photographed images (digital images), a function to send and receive digital data via the network 120, and a function to create a pair of public and secret private keys.

The certification authority 130 is a reliable, public, third party organization and has a secret key, a public key and public information, and it issues digital certificates on which digital signatures have been rendered using public information.

The network 120 is a means to connect devices or systems and includes, network systems such as, for example, local area network (LAN) and the Internet.

In the present embodiment, the network 120 shall be the Internet as one example, but other network systems are also applicable.

<Internal Configuration of the Digital Camera 110>

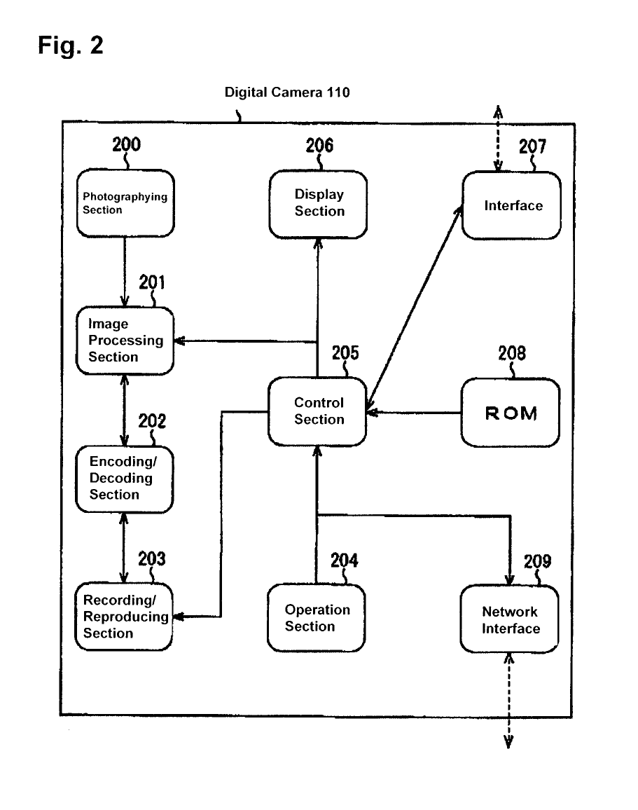

As shown in FIG. 2, the digital camera 110 comprises a photographing section 200, an image processing section 201, an encoding/decoding section 202, a recording and reproducing section 203, an operation section 204, a control section 205, a display section 206, an interface 207, a ROM 208, and a network interface 209. It is noted that each of the aforementioned sections may be realized by a hardware or software module.

The operation section 204 instructs processing operations to the digital camera 110. For example, the operation section 204 instructs operations such as creating a pair of public and secret keys or preparing a certificate request.

The control section 205 comprises a CPU (includes microcomputers and memory that can store predetermined program codes) and governs the operation control of the entire digital camera 110.

The photographing section 200 photographs optical images of subjects and obtains photographed images of the subjects.

The image processing section 201 converts the photographed images obtained by the photographing section 200 into image data (digital image) in a predetermined format and attaches electronic watermark information to the digital images through any technology of one's choice for attaching electronic watermark.

The encoding/decoding section 202 renders a predetermined high efficiency encoding processing (for example, encoding processing that performs variable-length encoding after DCT conversion and/or quantization) on the digital images after they have been processed by the image processing section 201.

For example, the encoding/decoding section 202 uses the JPEG (Joint Photographic Experts Group) method as a technology to encode digital images.

The recording and reproducing section 203 records on a recording medium, which is omitted from drawings, the digital images after they have been processed by the encoding/decoding section 202.

The display section 206 displays on EVF (electric viewfinder) or liquid crystal panels photographed images obtained by the photographing section 200.

The interface 207 sends and receives digital images to and from external equipment such as computer equipment.

The ROM 208 stores information concerning the functions of the digital camera 110.

The network interface (NETIF) 209 controls operations for sending and receiving data via the network 120, and also diagnoses connection status.

The recording and reproducing section 203 described above reproduces data recorded on a recording medium omitted from drawings.

In this case, the encoding/decoding section 202 decompression-decodes the reproduced data (compressed data). The image processing section 201 processes the image data decoded by the encoding/decoding section 202 and provides the result to the display section 206.

<A Series of Operations by the System 100>

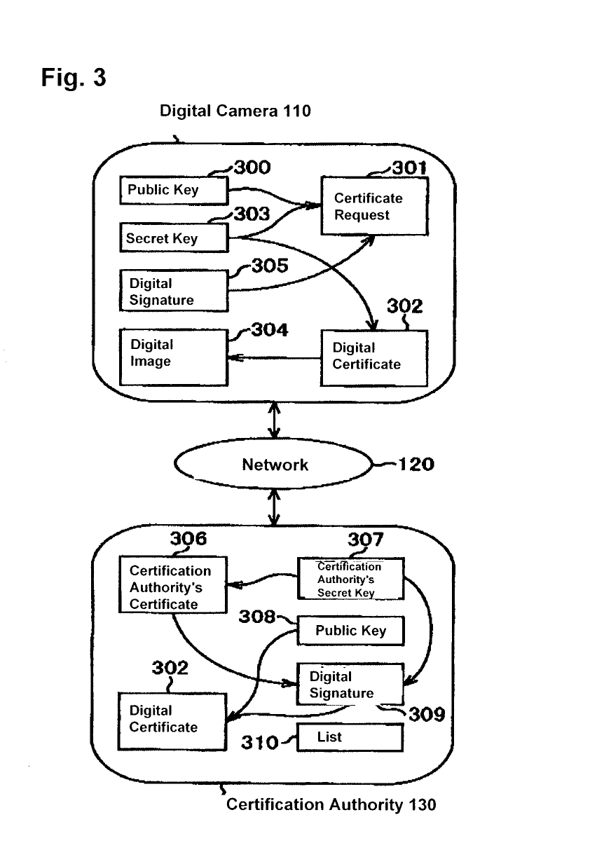

Next, referring to FIG. 3, descriptions will be made as to the operations that take place in the system 100 when the digital camera 110 photographs a subject, a digital certificate is obtained from the certification authority 130 via the network 120, and the digital certificate is attached as electronic watermark information to the photographed image (digital image) within the digital camera 110 after the subject is photographed by the digital camera 110.

First, a user presses a shutter button (omitted from drawings) provided in the operation section 204 of the digital camera 110.

The digital camera 110 through its control section 205 detects the operation of the shutter button, and at the same time sends a certificate request 301 with a public key 300 attached to the certification authority 130 via the network interface 209, in order to obtain a digital certificate 302.

Upon receiving the certificate request 301, the certification authority 130 verifies the user of the digital camera 110, encrypts a digest of a certificate (a certification authority's certificate 306) using a certification authority's secret key 307, and creates a digital signature 309.

Next, the certification authority 130 creates a digital certificate 302, which is information such as the certification organization name and issue date and the digital signature 309 that are encrypted using a public key 308 based on known encryption technology, and sends the digital certificate 302 to the digital camera 110 via the network 120.

The digital camera 110 receives the digital certificate 302 from the certification authority 130 via the network interface 209.

Next, the digital camera 110 checks that the digital certificate 302 has been issued by the certification authority 130 by decoding the digital certificate 302 using a secret key 303, re-encrypts the digital certificate 302 using the secret key 303, and has the image processing section 201 attach the re-encrypted digital certificate 302 as electronic watermark information to the digital image (photographed image) that is the target of processing.

The method for attaching electronic watermark information may be any known, commonly used method.

Sending and receiving of various information (e.g., the certificate request 301 and the digital certificate 302) in the system 100 can be easily realized through CGI (common gateway interface) using HTTP (Hypertext Transfer Protocol), for example.

<Detailed Operations of the Digital Camera 110>

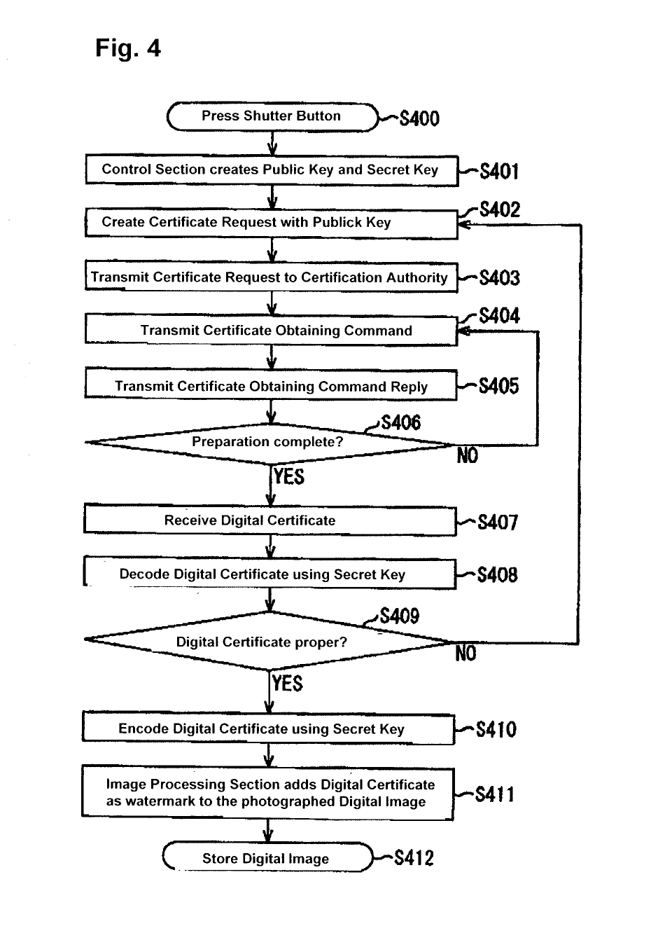

FIG. 4 describes the operations of the digital camera 110 in detail.

The operations shown in FIG. 4 include operations that take place when the user photographs a subject of his or her choice, from the time the user presses the shutter button (omitted from drawings) of the operation section 204 of the digital camera 110 to the time that electronic watermark information is attached to a digital image obtained from the photographing.

First, the user presses a shutter button (omitted from drawings) provided in the operation section 204 of the digital camera 110 (step S400).

Next, the digital camera 110 through its control section 205 detects the operation of the shutter button, and at the same time creates a pair of the public key 300 and the secret key 303, which are required to create the certificate request 301, to check the digital certificate 302, and to create a digital signature 305 (step S401).

Next, the digital camera 110 through its control section 205 creates the certificate request 301 with the public key 300, which was created in step S401, attached to it (step S402), sends this to the certification authority 130 via the network interface 209, and in this way requests the certification authority 130 to issue the digital certificate 302 (step S403).

Next, the digital camera 110 through its control section 205 sends a certificate obtaining command to the certification authority 130 via the network interface 209 (step S404).

The purpose of the certificate obtaining command is to check whether the certification authority 130 has completed the creation of the digital certificate 302.

Next, the digital camera 110 through its control section 205 waits for a reply (a certificate obtaining command reply) from the certification authority 130 to arrive via the network interface 209 and continues to send the certificate obtaining command in step S404 until the certificate obtaining command reply is sent from the certification authority 130 (steps S404-S406).

Next, upon recognizing through its control section 205 that the certificate obtaining command reply has been sent from the certification authority 130 (i.e., recognizing that the creation of the digital certificate 302 has been completed), the digital camera 110 receives the digital certificate 302 from the certification authority 130 via the network interface 209 (step S407), and decodes the digital certificate 302 using the secret key 303 that was created in step S402 (step S408).

Next, the digital camera 110 through its control section 205 determines whether the content of the digital certificate 302 as decoded in step S408 is proper (i.e., whether the digital certificate 302 was created by the certification authority 130) (step S409).

If as a result of the determination made in step S409, the content of the digital certificate 302 is found not to be proper, the digital camera 110 through its control section 205 recognizes that the digital certificate 302 has been altered by a third party and repeats the processing from step S402.

On the other hand, if as a result of the determination made in step S409, the content of the digital certificate 302 is found to be proper, the digital camera 110 through its control section 205 recognizes that the digital certificate 302 has been issued properly from the certification authority 130 and re-encrypts the digital certificate 302 using the secret key 303 that was created in step S401 (step S410).

The digital camera 110 through its image processing section 201 embeds the certificate 302 that was encrypted in step S410 as electronic watermark information into a digital image 304 obtained by the photographing section 200 (step S411) and stores it (step S412).

<Detailed Functions of the Certification Authority 130>

First, the certification authority 130 is a third party organization that issues the digital certificate 302 to users and to lower certification authorities.

Among the primary functions of the certification authority 130 is a function to create the digital signature 309 and issue the digital certificate 302 in response to the certificate request 301. In addition, the certification authority 130 has a function to retain a list 310 of the digital certificates 302 that are no longer valid. The list 310 is used to check the validity of the digital certificates 302 that have been issued.

Furthermore, the certification authority 130 has the certification authority's secret key 307, which is used to create the digital signatures 309, and a certification authority's certificate 306, which is used to verify users' certificates.

<The Certificate Request 301 Created by the Digital Camera 110>

The certificate request 301 created by the digital camera 110 can be as defined, for example, in X. 509 of ITU-T (International Telecommunications Union, Telecommunications Standards Section) Recommendations, and it is used to notify the certification authority 130 of a request to issue the digital certificate 302.

The certificate request 301 comprises user information (information such as organization the user belongs to, user's identification and name), the public key 300 and the digital signature 305.

Due to the fact that a signature, which is the digital signature 305 that was created based on the secret key 303 of the digital camera 110, is contained in the certificate request 301, the public key 300 that is contained in the certificate request 301 can be used to check for alterations.

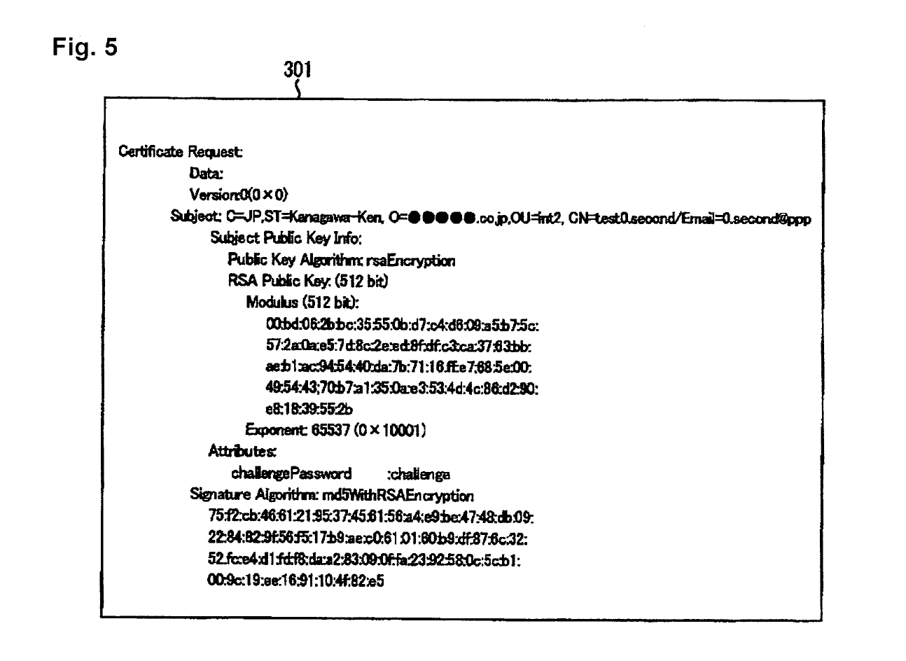

FIG. 5 is an example of the certificate request 301 issued by the digital camera 110. FIG. 5 is shown in text format to make the content of the certificate request 301 easy to understand, but certificate request 301 is in fact in binary format.

<The Digital Certificate 302 Created by the Certification Authority 130>

The digital certificate 302 created by the certification authority 130 can be as defined, for example, in X. 509 of ITU-T Recommendations, and includes user information (information such as organization the user belongs to, user's identification and name), the public key 308, expiration date, serial number and the digital signature 309.

The digital certificate 302 can be made public on the network 120, and verification of and encrypted communication with the holder of the secret key, i.e., the correct user, are possible by using the public key 308 that is included in the digital certificate 302.

Additionally, any alterations to the digital certificate 302 can be discerned due to the fact that the digital signature 309 is included in the digital certificate 302.

Specifically, when the certification authority 130 issues the digital certificate 302, for example, a digest (fingerprint) of the digital certificate 302 is obtained through an appropriate hash algorithm, and the digest that has been encrypted using the secret key 307 of the certification authority 130 becomes the digital signature 309. As a result, even if the digital certificate 302 is altered, the digital signature 309 cannot be created unless the secret key 307 of the certification authority 130 is known.

Furthermore, due to the fact that an original and independent serial number is assigned by the certification authority 130 to each of the digital certificates 302, even if certificate requests 301 whose contents are identical are issued to the certification authority 130, for example, the digital certificates 302 that are issued in response would have completely different contents. This maintains the uniqueness of each digital certificate 302.

By attaching the digital certificate 302 as electronic watermark information to the digital image obtained by the digital camera 110, the digital image itself becomes secure, and the validity of the digital certificate 302 can be checked by anyone who has the public key.

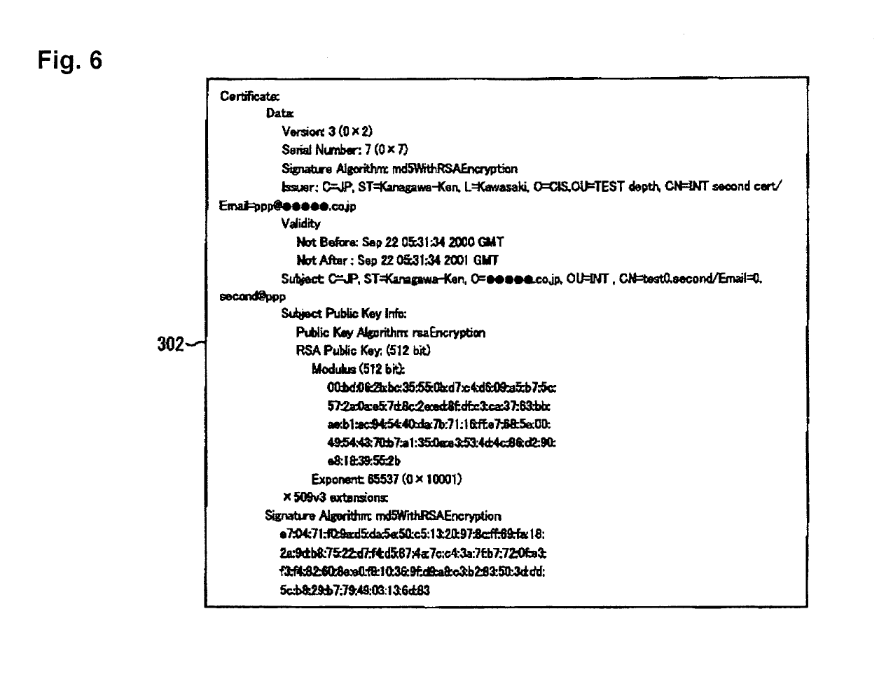

FIG. 6 shows an example of the digital certificate 302 issued by the certification authority 130 before the digital certificate 302 is encrypted using the secret key 307. FIG. 6 is shown in text format to make the content of the digital certificate 302 easy to understand, but the digital certificate 302 is in fact in binary format.

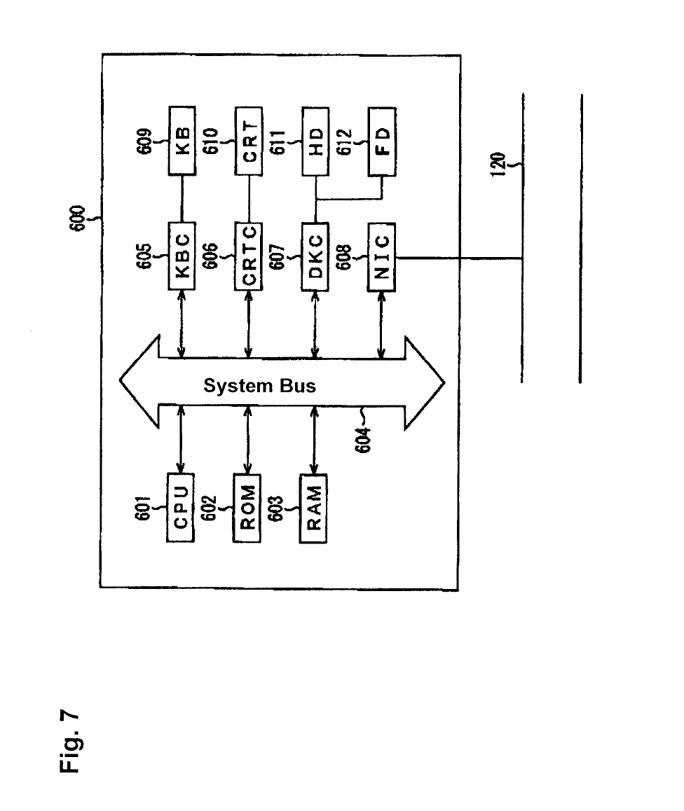

FIG. 7 shows one example of a computer 600 that realizes the functions described above.

The computer 600 comprises, as shown in FIG. 7, a CPU 601, a ROM 602, a RAM 603, a keyboard controller (KBC) 605 of a keyboard (KB) 609, a CRT controller (CRTC) 606 of a CRT display (CRT) 610 that is a display section, a disk controller (DKC) 607 of a hard disk (HD) 611 and a flexible disk (FD) 612, and a network interface card (NIC) 608 for communication via the network 120, where the elements are communicatively connected to each other via a system bus 604.

The CPU 601 consolidates the control of various components connected to the system bus 604 by executing software stored in the ROM 602 or the HD 611, or software provided by the FD 612.

In other words, the CPU 601 performs controls to realize the operations of the present embodiment described above by reading and executing from the ROM 602, the HD 611 or the FD 612 processing programs that follow a predetermined processing sequence.

The RAM 603 functions as a primary memory or work area for the CPU 601.

The KBC 605 controls input of instructions from the KB 609 or pointing devices omitted from drawings.

The CRTC 606 controls displays on the CRT 610.

The DKC 607 controls access to the HD 611 and the FD 612 that store a boot program, various applications, editing files, user files, network management programs, and predetermined processing programs.

The NIC 608 exchanges data bidirectionally with devices or systems on the network 120.

As described above, the present invention is configured to request to, and obtain from, a predetermined organization (e.g., a reliable, public, third party organization) via a communication means (e.g., a network) a digital certificate for any digital information (e.g., digital images obtained by photographing with a digital camera) of one's choice. As a result of this, digital certificates with high reliability can be used as information to prove the admissibility of any digital information of one's choice.

Specifically, for example, when photographing with a digital camera, the digital camera requests a certification authority (e.g., a predetermined organization) to issue a digital certificate, and the digital certificate obtained thereby is embedded in a photographed image (e.g., a digital image) as electronic watermark information. As a result, the digital image can be securely protected from any alterations. Further, even if the digital image were to be deliberately altered, due to the fact that the electronic watermark information (i.e., the digital certificate issued by the certification authority) attached to the digital image could not be restored, an unrestored digital certificate becomes a proof that the digital image has been altered. Moreover, due to the fact that the electronic watermark information attached to the digital image is the digital certificate issued by the certification authority, the uniqueness of the digital image to which the digital certificate is attached can be ensured.

As a result, digital information that is unalterable, reliable and has high admissibility can be provided according to the present invention.

(Second Embodiment)

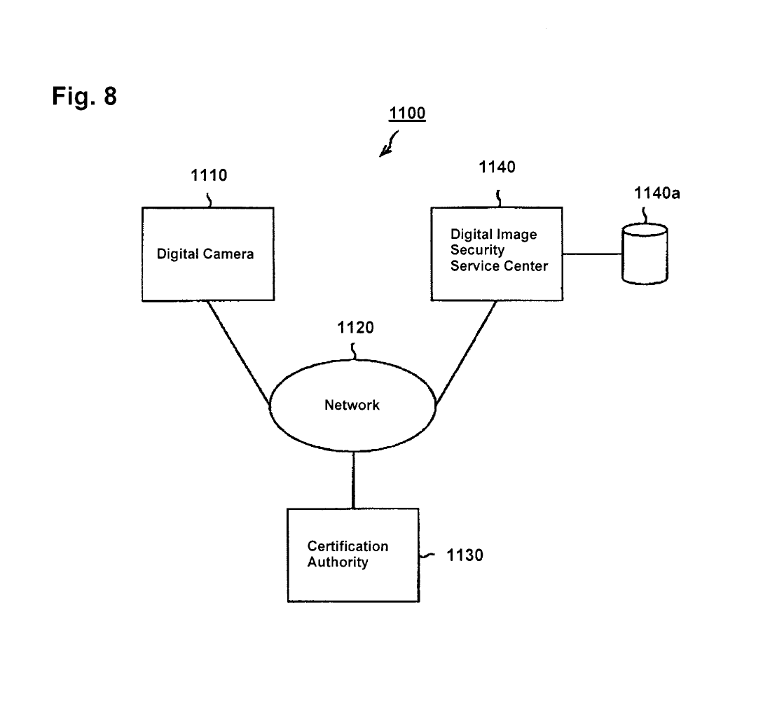

The present invention can be applied, for example, to a system 1100 shown in FIG. 8.

In the system 1100 in accordance with a second embodiment of the present embodiment, a digital image security service center 1140 in place of a digital camera 1110 requests a certification authority 1130 (a reliable, public, third party organization) that is accessible via a network 1120 to issue a digital certificate and provides the digital certificate thus obtained to the digital camera 1110; the digital camera 1110 embeds in a photographed image (a digital image) the digital certificate provided by the digital image security service center 1140 as electronic watermark information; and the certification authority 1130 encrypts the digital certificate using the public key method and transfers it via the network 1120.

The system 1100 according to the present embodiment has a configuration that makes the highly reliable digital certificate managed by the certification authority 1130 usable as electronic watermark information, and that has the digital image security service center 1140 request the certification authority 1130 for the digital certificate that is to be used as the electronic watermark information; consequently, the processing burden on the digital camera 1110 is reduced and digital images that are unalterable, reliable and have high admissibility can be provided.

Further, the present embodiment includes ways to obtain digital certificates even when digital certificates could not be obtained due to communication errors and ways to prevent alterations.

Below, we will describe in detail the configuration and operations of the system 1100 according to the present embodiment.

<Overall Configuration of the System 1100>

As shown in FIG. 8, the system 1100 has a configuration in which the digital camera 1110, the certification authority 1130, and the digital image security service center 1140 are connected communicatively with one another via the network 1120.

To simplify the description, FIG. 8 shows one each of the digital camera 1110, the certification authority 1130, and the digital image security service center 1140 to the network 1120, but the number of these elements connected is not limited to one each.

That is, any number of the digital image security service center 1140 may be relayed, and the certification authority 1130 and the digital image security service center 1140 may be combined.

The details of the digital camera 1110 will be described in greater detail later, but the digital camera 1110 has, in addition to basic functions of a camera, a function to attach electronic watermark information to photographed images (digital images), a function to send and receive digital data via the network 1120, and a function to create a pair of public and secret keys.

The digital image security service center 1140 is an organization that provides services to ensure digital images and has a database 1140a to retain (to manage) various information, as well as the following as its primary functions:

To closely possess and manage information concerning users who use its services, serial numbers used to identify the digital cameras 1110 owned by the users, a public key of the certification authority 1130, and a secret key and a public key of each of the digital cameras 1110.

To prepare and send a certificate request to the certification authority 1130 in response to a request from the digital camera 1110.

To send the digital certificate issued by the certification authority 1130 to the digital camera 1110.

To charge the user who used its services.

The certification authority 1130 is a reliable, public, third party organization and has a secret key, a public key and public information, and it issues digital certificates on which digital signatures have been rendered using public information. The digital image security service center 1140 provides a service to act as an agent to obtain the certificate issued and to ensure that the certificate and the digital data match.

The network 1120 connects devices or systems and includes network systems such, for example, as local area network (LAN) and the Internet.

In the present embodiment, the network 1120 shall be the Internet as one example, but other network systems are also applicable.

<Internal Configuration of the Digital Camera 1110>

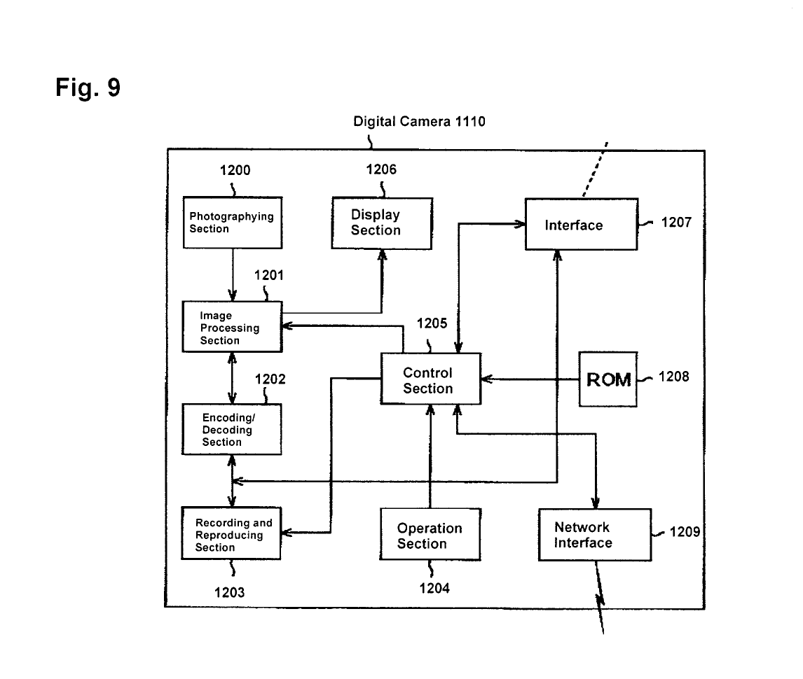

As shown in FIG. 9, the digital camera 1110 comprises a photographing section 1200, an image processing section 1201, an encoding/decoding section 1202, a recording and reproducing section 1203, an operation section 1204, a control section 1205, a display section 1206, an interface 1207, a ROM 1208, and a network interface 1209.

The operation section 1204 instructs processing operations to the digital camera 110. For example, the operation section 204 instructs operations such as creating a pair of public and secret keys or preparing a certificate request.

The control section 1205 comprises a CPU (includes microcomputers and memory that can store predetermined program codes) and governs the operation control of the entire digital camera 110.

The program used to execute the present invention is stored in the ROM 1208; the digital camera 1110 functions as an information processing device that executes the present invention through the control of the control section 1205, which controls the CPU to read and execute the program.

The photographing section 1200 photographs optical images of subjects and obtains photographed images of the subjects.

The image processing section 1201 converts the photographed images obtained by the photographing section 1200 into image data (digital image) in a predetermined format and embeds electronic watermark information in the digital image.

The encoding/decoding section 1202 renders a predetermined high efficiency encoding processing (for example, encoding processing that performs variable-length encoding after DCT conversion and/or quantization) on the digital images after they have been processed by the image processing section 201.

For example, the encoding/decoding section 1202 uses the JPEG method as a technology to encode digital images.

The recording and reproducing section 1203 records on a recording medium, which is omitted from drawings, the digital images after they have been processed by the encoding/decoding section 1202.

The recording and reproducing section 1203 also reproduces data recorded on a recording medium omitted from drawings. In this case, the encoding/decoding section 1202 decompression-decodes the reproduced data (compressed data). The image processing section 1201 processes the image data decoded by the encoding/decoding section 1202 and provides the result to the display section 1206.

The display section 1206 displays on EVF or liquid crystal panels photographed images obtained by the photographing section 1200.

The interface 1207 sends and receives digital images to and from external equipment such as computer equipment.

The network interface (NETIF) 1209 controls operations for sending and receiving data via the network 1120, and also diagnoses connection status.

<A Series of Operations by the System 1100>

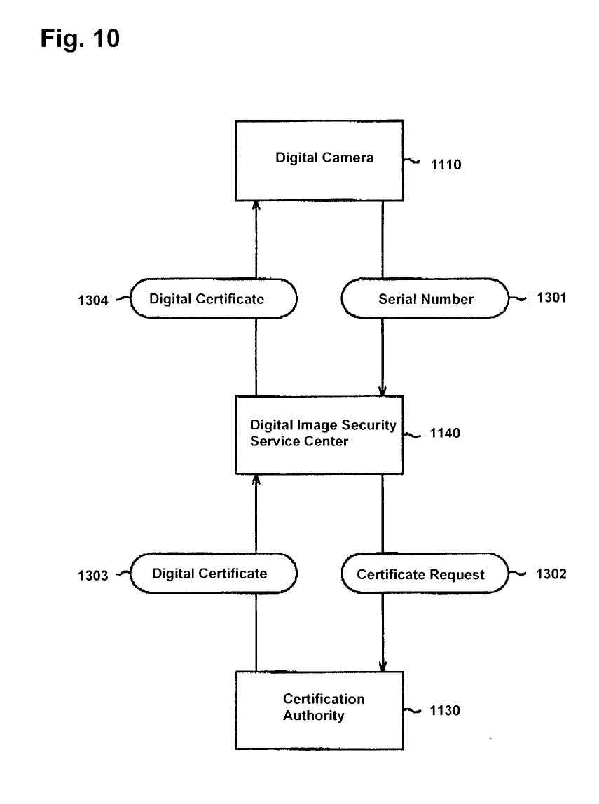

FIG. 10 shows a series of operations by the system 1110.

First, a user who decides to use services provided by the digital image security service center 1140 through the digital camera 1110 enters into a contract with the digital image security service center 1140 when he or she purchases the digital camera 1110.

Upon entering into the contract, the user registers a secret key, a public key, and a serial number that the digital camera 1110 has, as well as user information (information such as the user's name, address, bank account for automatic payments), with the digital image security service center 1140.

The digital image security service center 1140 stores the registered information for the digital camera 1110 in the database 1140a and registers the public key of the digital camera 1110 with the certification authority 1130.

After the processing described above is completed, the system 1100 operates in the following manner when the user of the digital camera 1110 photographs any subject of his or her choice.

First, the user presses a shutter button (omitted from drawings) provided in the operation section 1204 of the digital camera 1110.

The digital camera 1110 through its control section 1205 detects the operation of the shutter button, and at the same time sends a serial number 1301 of the digital camera 1110 to the digital image security service center 1140 via the network interface 1209.

The digital image security service center 1140 receives the serial number 1301 from the digital camera 1110 and extracts from the database 1140a user information and the secret key of the digital camera 1110 that correspond to the serial number 1301.

The digital image security service center 1140 uses the information (user information and the secret key of the digital camera 1110) extracted from the database 1140a and executes the following processing.

In the description of the present embodiment, only the serial number is used as the information that is sent from the digital camera 1110, but the information sent from the digital camera 1110 may also be the user name or password. That is, any information that specifies the information processing device or the operator that obtained the digital data may be used.

First, the digital image security service center 1140 creates a certificate request 1302 to obtain a digital certificate 1303 from the certification authority 1130.

Next, the digital image security service center 1140 creates a signature using the secret key of the digital camera 1110.

Next, the digital image security service center 1140 attaches the signature to the certificate request 1302.

Next, the digital image security service center 1140 encrypts the certificate request 1302 using the public key of the certification authority 1130.

The digital image security service center 1140 sends the certificate request 1302 to the certification authority 1130.

The certification authority 1130 receives the certificate request 1302 from the digital image security service center 1140 and executes the following processing.

First, the certification authority 1130 decodes the certificate request 1302 using a secret key.

Next, the certification authority 1130 verifies the user using the public key of the digital camera 1110, based on the certificate request 1302.

Next, the certification authority 1130 uses the secret key of the certification authority 1130 to encrypt the certificate digest and thereby creates a signature.

Next, the certification authority 1130 encrypts the signature, as well as information such as the certification organization name and issue date, using a public key of the digital image security service center 1140 based on an encryption technology that uses public key, and the result obtained becomes a digital certificate 1303.

The certification authority 1130 sends the digital certificate 1303 to the digital image security service center 1140.

The digital image security service center 1140 receives the digital certificate 1303 from the certification authority 1130 and executes the following processing.

First, the digital image security service center 1140 uses the secret key to decode the digital certificate 1303.

Next, the digital image security service center 1140 uses the public key of the certification authority 1130 to check whether the digital signature obtained through decoding is a proper one.

The digital image security service center 1140 encrypts the digital certificate 1303 using the public key of the digital camera 1110 and sends the result (1304) to the digital camera 1110.

The digital camera 1110 obtains the digital certificate 1304 from the digital image security service center 1140 via the network interface 1209 and executes the following processing.

First, the digital camera 1110 uses the secret key to decode the digital certificate

Next, the digital camera 1110 uses the secret key to re-encrypt the digital certificate

The digital camera 1110 attaches the digital certificate 1304 as electronic watermark information to the digital image obtained from photographing.

The method for attaching electronic watermark information may be any known, commonly used method.

Sending and receiving of various information (e.g., the certificate request 1302 and the digital certificate 1303/1304) in the system 1100 can be easily realized through CGI using HTTP, for example.

<Detailed Operations of the Digital Camera 1110>

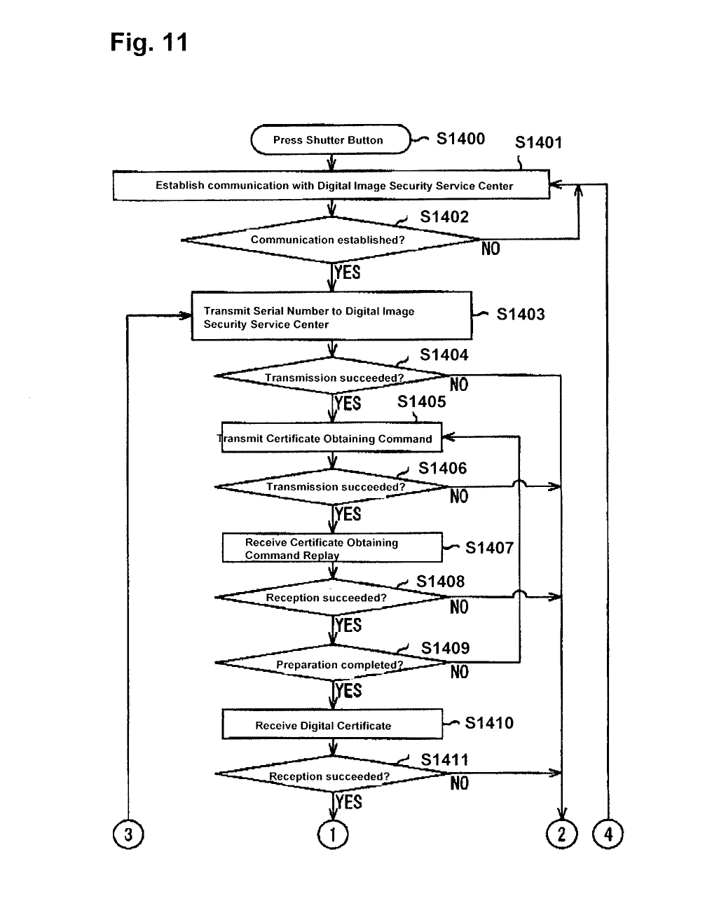

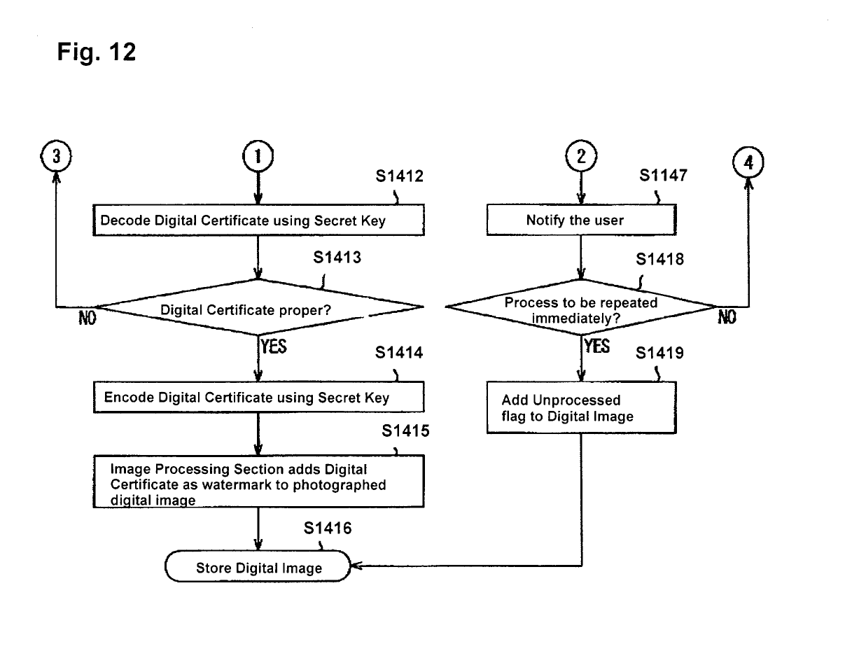

Referring to flowcharts shown in FIGS. 11 and 12, the operations of the digital camera 110 are described in detail.

Specifically, the operations shown in FIGS. 11 and 12 include operations that take place when the user photographs a subject of his or her choice, from the time the user presses the shutter button (omitted from drawings) of the operation section 1204 of the digital camera 1110 to the time that electronic watermark information is attached to a digital image obtained from the photographing.

First, as shown in FIG. 11, the user presses a shutter button (omitted from drawings) provided in the operation section 1204 of the digital camera 1110 (step S1400).

Next, the digital camera 1110 through its control section 1205 detects the operation of the shutter button, and at the same time establishes communication with the digital image security service center 1140 (step S1401).

Once it is confirmed that communication with the digital image security service center 1140 has been established (step S1402), the digital camera 1110 through its control section 1205 sends the serial number 1301 of the digital camera 1110 to the digital image security service center 1140 via the network interface 1209 (step S1403).

If the transmission in step S1403 is successful (step S1404), the digital camera 1110 through its control section 1205 sends a certificate obtaining command to the digital image security service center 1140 via the network interface 1209 (step S1405).

The purpose of the certificate obtaining command is to check whether the digital image security service center 1140 has completed preparations to send the digital certificate 1303 (and the digital certificate 1304 after the processing by the digital image security service center 1140) to be obtained from the certification authority 1130 and other necessary processing.

If the transmission of the certificate obtaining command is successful (step S1406), the digital camera 1110 through its control section 1205 waits for a reply (a certificate obtaining command reply) from the digital image security service center 1140 to arrive via the network interface 1209 and continues to send the certificate obtaining command in step S1404 until the certificate obtaining command reply is sent from the digital image security service center 1140 (steps S1405-S1409).

Next, upon recognizing through its control section 1205 that the certificate obtaining command reply has been sent from the digital image security service center 1140 (i.e., recognizing that the preparations to send the digital certificate 1304 has been completed), the digital camera 1110 receives the digital certificate 1304 from the digital image security service center 1140 via the network interface 1209 (step S1410); when this is successfully received (step S1411), the digital camera 1110 decodes the digital certificate 1304 using the secret key (i.e., the secret key that was registered with the digital image security service center 1140) of the digital camera 1110, as shown in FIG. 12 (step S1412).

Next, the digital camera 1110 through its control section 1205 determines whether the content of the digital certificate 1304 as decoded in step S1412 is proper (i.e., whether the digital certificate 1304 was created by the certification authority 1130) (step S1413).

If as a result of the determination made in step S1413, the content of the digital certificate 1304 is found not to be proper, the digital camera 1110 through its control section 1205 recognizes that the digital certificate 1304 has been altered by a third party and repeats the processing from step S1403.

On the other hand, if as a result of the determination made in step S1413, the content of the digital certificate 1304 is found to be proper, the digital camera 1110 through its control section 1205 recognizes that the digital certificate 1304 has been issued properly by the certification authority 1130 and re-encrypts the digital certificate 1304 using the secret key of the digital camera 1110 (step S1414).

Next, the digital camera 1110 through its image processing section 1201 embeds the digital certificate 1304 that was re-encrypted in step S1414 as electronic watermark information in the digital image that was obtained by the photographing section 1200 (step S1415) and stores it (step S1416).

In the meantime, if communication with the digital image security service center 1140 is not established in step S1402, several attempts are made until communication is established (attempts may be made any number of times).

Although omitted from the flowchart, even if communication is not established after the predetermined number of attempts are made in step S1402, the processing proceeds to step S1417.

Next, we will describe the processing that takes place when sending or receiving of information in step S1404, step S1406, step S1408 or step S1411 fails.

First, the digital camera 1110 through its control section 1205 displays on the display section 1206 of the digital camera 1110 that the attempt has failed (step S1417).

Next, the digital camera 1110 through its control section 1205 displays a question on its display section 1206 whether to attempt to reestablish communication and waits for an input from the user; if the user indicates that he or she wishes to repeat the processing immediately, the processing is repeated from step S1401 (step S1418).

This choice gives the user a convenience of being able to repeat the processing later if he or she wishes at this point to continue instead with photograph processing.

On the other hand, if the user indicates in step S1418 that he or she does not wish to repeat the processing immediately, the digital camera 1110 through its control section 1205 attaches an “unprocessed flag” to the digital image (step S1419) and stores it (step S1416).

The image stored at this time is recorded on a storage medium such as a memory card, but since it is an image without an adequate electronic watermark attached to it, the control section 1205 restricts access to the image data to prevent the user from making any changes to the image, such as rotating it or color correcting it. Due to the fact that image data that are temporarily stored without electronic watermarks are nevertheless stored in the storage medium, the image data can be kept in an internal buffer indefinitely, which prevents such problems as data corruption. Then, as described later, after an electronic watermark is attached to the stored image, the control section 1205 releases the access restriction process described above, and allows viewing of the image and/or other operations on the image.

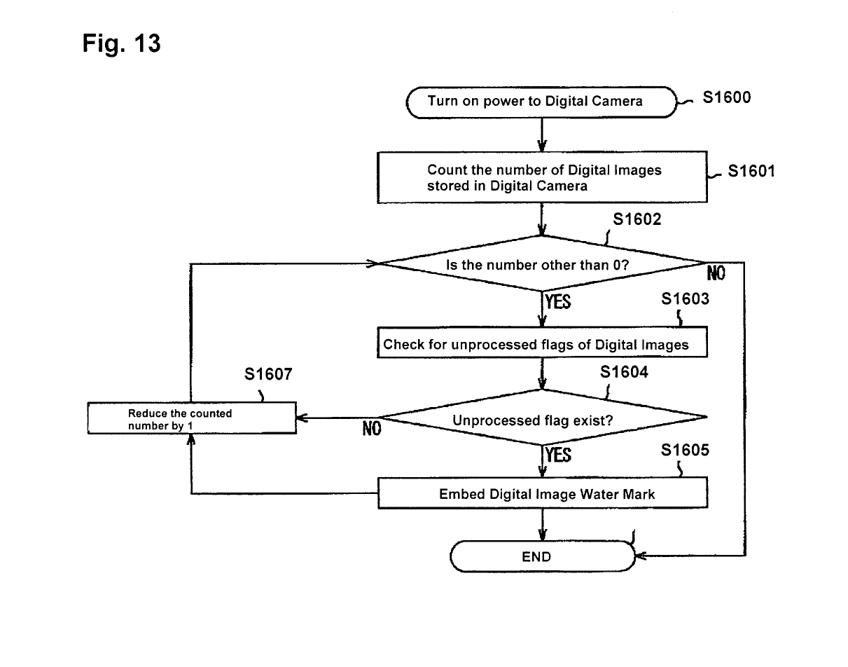

If sending or receiving information to and from the digital image security service center 1140 fails (in step S1404, step S1406, step S1408 or step S1411) and processing of the unprocessed digital image is attempted again, the repeat processing is indicated by a flowchart in FIG. 13, for example.

The operations shown in FIG. 13 include operations by the digital camera 1110 that take place from the time that the user presses a power source button (omitted from drawings) of the digital camera 1110 (step S1600) to the time that electronic watermark information is attached to a digital image retained in the digital camera 1110.

First, the digital camera 1110 through its control section 1205 counts the number of digital images that are retained in the digital camera 1110 (step S1601).

Next, the digital camera 1110 through its control section 1205 judges whether the count is zero (step S1602).

If the count found as a result of step S1602 is not zero (i.e., the result of step S1062 is other than zero), the digital camera 1110 through its control section 1205 retrieves a digital image (step S1603), and determines whether an unprocessed flag is attached to the digital image (step S1604).

If as a result of step S1604 an unprocessed flag is found not to be attached to the digital image, the digital camera 1110 through its control section 1205 reduces the count by one (step S1607) and returns to step S1602.

On the other hand, if as a result of step S1604 an unprocessed flag is found to be attached to the digital image, the digital camera 1110 through its control section 1205 executes a processing (step S1605) to attach a watermark to the digital image (i.e., steps S1401-S1416) and reduces the count by one (step S1607).

After this, step S1602 to step S1607 are repeated until the count is zero. Once the count becomes zero, the processing is terminated (step S1608).

At this stage, the access restriction to prevent the user from making changes or alterations on the image is released, so that viewing of or other operations on the image become possible.

<Detailed Functions of the Digital Image Security Service Center 1140>

The digital image security service center 1140 is an organization that provides a service in the system 1100 to request issuance of digital certificates that can be used as electronic watermark information.

Primary functions of the digital image security service center 1140 are as follows:

To verify that the user is a user who entered into a contract with the digital image security service center 1140 in person or online (i.e., a user who is allowed to use the services described above), and to create the certificate request 1302 and issue it to the certification authority 1130 only if the user is the correct user. The digital image security service center 1140 then obtains the digital certificate 1303 from the certification authority 1130 in place of the user and sends it to the digital camera 1110 of the user.

To closely manage (retain) in the database 1140a the secret key, the public key and the serial number 1301 that the digital camera 1110 has, as well as user information (information such as the user's name, address, bank account for automatic payments), that were obtained when the user entered into the contract with the digital image security service center 1140.

To charge the user who used the services of the digital image security service center 1140.

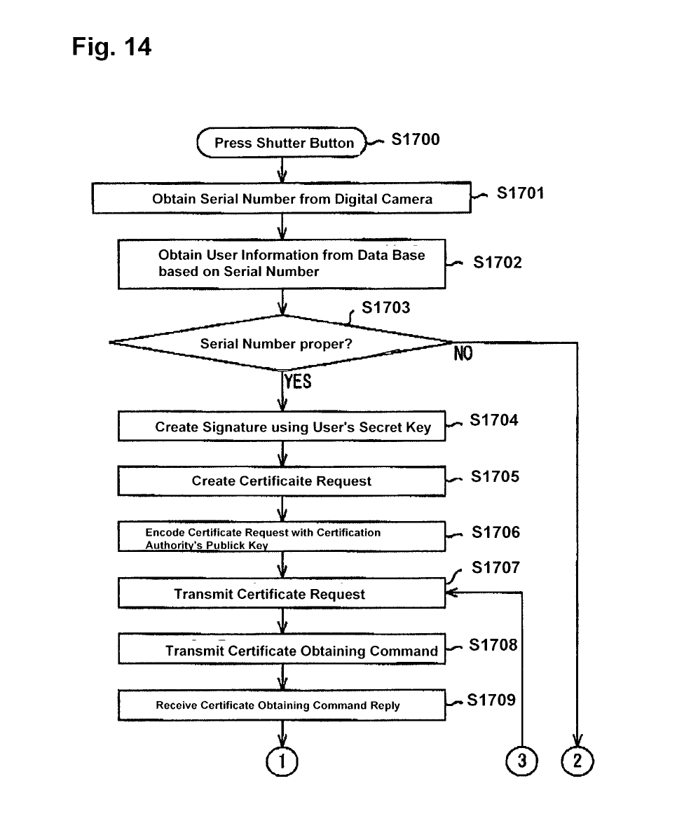

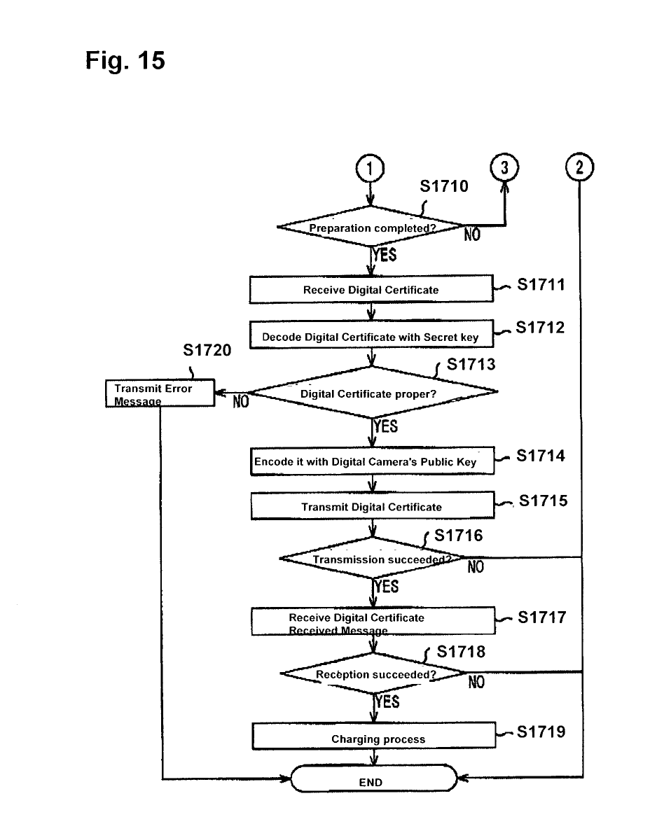

FIGS. 14 and 15 show in detail the operations of the digital image security service center 1140.

Specifically, the operations shown in FIGS. 14 and 15 include operations that take place when the user photographs a subject of his or her choice, from the time that the user presses the shutter button (omitted from drawings) of the operation section 1204 of the digital camera 1110, at which time the digital image security service center 1140 receives the serial number 1301 sent from the digital camera 1110, to the time that the digital image security service center 1140 based on this obtains the digital certificate 1303 from the certification authority 1130 and provides it to the digital camera 1110.

First, when the user photographs a subject of his or her choice with the digital camera 1110, the user presses a shutter button (omitted from drawings) provided in the operation section 1204 of, as shown in FIG. 14. This causes the serial number 1301 of the digital camera 1110 to be sent to the digital image security service center 1140 from the digital camera 1110 (step S1700).

Next, the digital image security service center 1140 receives the serial number 1301 from the digital camera 1110 via the network 1120 (step S1701).

Next, the digital image security service center 1140 obtains from the database 1140a information (the secret key and public key of the digital camera 1110 and user information) that corresponds to the serial number 1301 that was obtained in step S1701 (step S1702).

Next, the digital image security service center 1140 determines whether obtaining the information in step S1702 was completed normally, i.e., whether the serial number 1301 that was sent from the digital camera 1110 was proper information and whether information that corresponds to the serial number 1301 was retained in the database 1140a (step S1703).

If as a result of the determination made in step S1703, the serial number 1301 from the digital camera 1110 is found not to be proper information, the digital image security service center 1140 terminates the processing (see FIG. 15).

On the other hand, if as a result of the determination made in step S1703, the serial number 1301 from the digital camera 1110 is found to be proper information, the digital image security service center 1140 uses the secret key of the digital camera 1110 that was obtained in step S1702 to create a digital signature (step S1704).

Next, the digital image security service center 1140 uses the digital signature created in step S1704 to create the certificate request 1302 (step S1705).

Next, the digital image security service center 1140 uses the public key of the certification authority 1130 to encrypt the certificate request 1302 created in step S1705 (step S1706).

Next, the digital image security service center 1140 sends the certificate request 1302 that was encrypted in step S1706 to the certification authority 1130 (step S1707).

Next, the digital image security service center 1140 issues a certificate obtaining command to the certification authority 1130 (step S1708).

The purpose of the certificate obtaining command is to check whether the certification authority 1130 has completed preparations to send the digital certificate 1303.

Next, the digital image security service center 1140 receives a reply to the certificate obtaining command (a certificate obtaining command reply) from the certification authority 1130 (step S1709), which serves as a way to determine whether the certification authority 1130 has completed preparations to send the digital certificate 1303, as shown in FIG. 15 (step S1710).

If as a result of the determination made in step S1710, the certification authority 1130 is found not to have completed preparations to send the digital certificate 1303, the digital image security service center 1140 repeats the processing from step S1707 (see FIG. 14, step S1707).

If as a result of the determination made in step S1710, the certification authority 1130 is found to have completed preparations to send the digital certificate 1303, the digital image security service center 1140 receives the digital certificate 1303 from the certification authority 1130 via the network 1120 (step S1711).

Next, the digital image security service center 1140 uses the secret key to decode the digital certificate 1303 that was received in step S1711 (step S1712).

Next, the digital image security service center 1140 uses the public key of the certification authority 1130 to check whether the digital certificate 1303 that was decoded in step S1712 is a proper one (step S1713).

If as a result of checking in step S1713 the digital certificate 1303 is found not to be a proper one, the digital image security service center 1140 notifies of this to the digital camera 1110 via the network 1120 (step S1720) and terminates the processing.

If as a result of checking in step S1713 the digital certificate 1303 is found to be a proper one, the digital image security service center 1140 uses the public key of the digital camera 1110 that is managed in the database 1140a to encrypt the digital certificate 1303 (step S1714).

Next, the digital image security service center 1140 sends the digital certificate 1303 that was encrypted in step S1714 (now the digital certificate 1304) to the digital camera 1110 via the network 1120 (step S1715).

Next, the digital image security service center 1140 determines whether the transmission in step S1715 was successful (step S1716), and terminates the processing if the transmission had failed.

Next, the digital image security service center 1140 receives a reception message (i.e., a message that the digital camera 1110 has completed the reception of the digital certificate 1304) for the digital certificate 1304 from the digital camera 1110 via the network 1120 (step S1717).

Next, the digital image security service center 1140 determines whether the reception in step S1717 was successful (step S1718), and terminates the processing if the reception had failed.

The digital image security service center 1140 obtains applicable information (user information and information such as account number) from the database 1140a, charges the user of the digital camera 1110 based on the information (step S1719), and terminates the processing.

<Detailed Functions of the Certification Authority 1130>

First, the certification authority 1130 is a third party organization that issues the digital certificate 1303 to users and to lower certification authorities.

Among the primary functions of the certification authority 1130 is a function to create a digital signature and issue the digital certificate 1303 in response to the certificate request 1302. In addition, the certification authority 1130 has a function to retain a list of the digital certificates 1303 that are no longer valid. The list is used to check the validity of the digital certificates 1303 that have been issued.

Furthermore, the certification authority 1130 has the certification authority's secret key, which is used to create digital signatures, and the certification authority's certificate, which is used to verify users' certificates.

<The Certificate Request 1302 Created by the Digital Image Security Service Center 1140>

The certificate request 1302 created by the digital image security service center 1140 can be as defined, for example, in X. 509 of ITU-T Recommendations, and it is used to notify the certification authority 1130 of a request to issue the digital certificate 1303.

The certificate request 1302 comprises user information (information such as organization the user belongs to, user's identification and name), the public key and the digital signature.

Due to the fact that a signature, which is the digital signature that was created based on the secret key of the digital camera 1110, is contained in the certificate request 1302, the public key that is contained in the certificate request 1302 can be used to check for alterations.

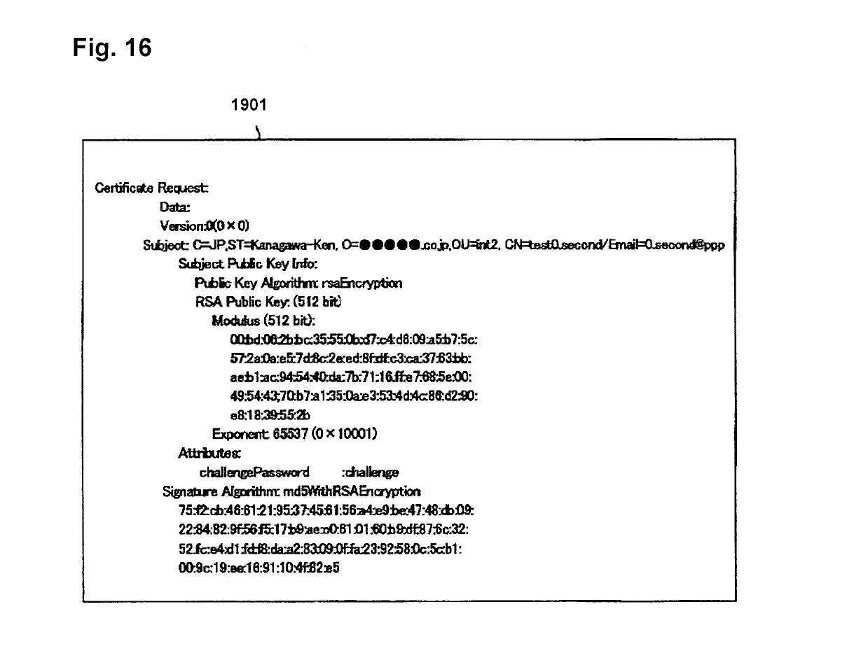

FIG. 16 is an example of a certificate request 1901 issued by the digital image security service center 1140.

FIG. 16 is shown in text format to make the content of the certificate request 1901 easy to understand, but certificate request 1901 is in fact in binary format.

<The Digital Certificate 1303 Created by the Certification Authority 1130>

The digital certificate 1303 created by the certification authority 1130 can be as defined, for example, in X. 509 of ITU-T Recommendations, and includes user information (information such as organization the user belongs to, user's identification and name), the public key, expiration date, serial number 1301 and the digital signature.

The digital certificate 1303 can be made public on the network 1120, and verification of and encrypted communication with the holder of the secret key, i.e., the correct user, are possible by using the public key 1307 that is included in the digital certificate 1303.

Additionally, any alterations to the digital certificate 1303 can be discerned due to the fact that the digital signature is included in the digital certificate 1303.

Specifically, when the certification authority 1130 issues the digital certificate 1303, for example, a digest (fingerprint) of the digital certificate 1303 is obtained through an appropriate hash algorithm, and the digest that has been encrypted using the secret key of the certification authority 1130 becomes the digital signature. As a result, even if the digital certificate 1303 is altered, the digital signature cannot be created unless the secret key of the certification authority 1130 is known.

Furthermore, due to the fact that an original and independent serial number is assigned by the certification authority 1130 to each of the digital certificates 1303, even if certificate requests 1302 whose contents are identical are issued to the certification authority 1130, for example, the digital certificates 1303 that are issued in response would have completely different contents. This maintains the uniqueness of each digital certificate 1303.

In addition, issue date information (i.e., information that indicates the date and time the shutter button was pressed on the digital camera 1110) can be attached to the digital certificate 1303.

By attaching the digital certificate 1303 as electronic watermark information to the digital image obtained by the digital camera 1110, the digital image itself becomes secure, and the validity of the digital certificate 1303 can be checked by anyone who has the public key.

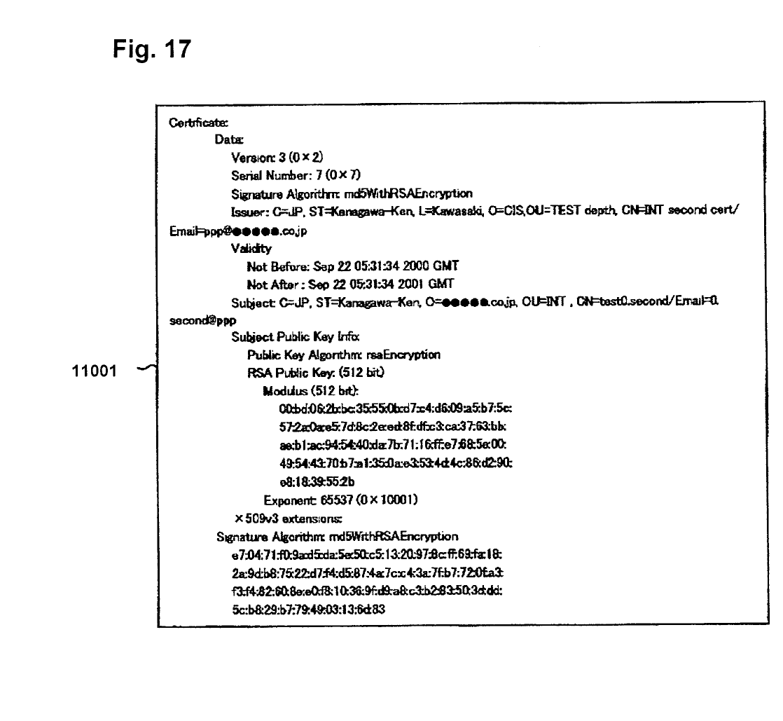

FIG. 17 is an example of a digital certificate 11001 issued by the certification authority 1130 before the digital certificate 11001 is encrypted using the secret key.

FIG. 17 is shown in text format to make the content of the digital certificate 11001 easy to understand, but the digital certificate 11001 is in fact in binary format.

(Third Embodiment)

In accordance with a third embodiment of the present invention, the system 1100 shown in FIG. 8 has a configuration and operations described below that differ from the second embodiment.

Below, only those parts of the configuration and operations that differ from the second embodiment are described in detail.

<Configurations and Operations as Features of a Digital Camera 1110 According to the Present Embodiment>

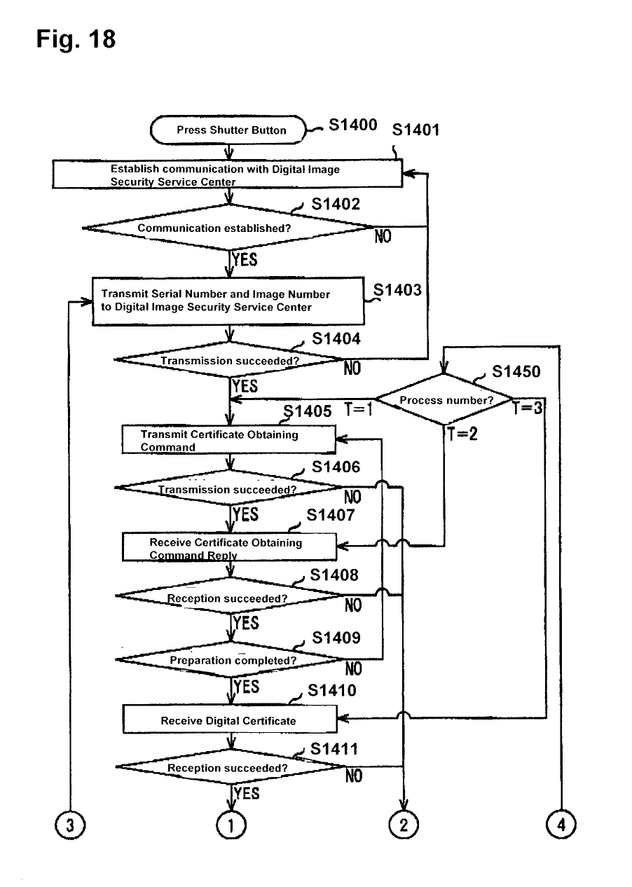

The digital camera 1110 according to the present embodiment operates according to the flowchart in FIG. 18, for example, in contrast to its operations according to the second embodiment (see FIGS. 11 and 12).

When communication is established between the digital camera 1110 and a digital image security service center 1140 (step S1402), the digital camera 1110 through its control section 1205 sends in step S1403 a serial number 1301 of the digital camera 1110 and image number to the digital image security service center 1140 via a network interface 1209.

Following this, the same processing as in the second embodiment (including the processing shown in FIG. 12) is executed; however, if sending or receiving of information fails in step S1406, step S1408 or step S1411 due to communication error or other reasons, the processing as described below takes place according to the present embodiment.

First, in step S1417 (see FIG. 12), the digital camera 1110 through its control section 1205 stores processing number T for the last processing it executed and displays on a display section 1206 that sending or receiving has failed.

The processing number T may be, for example, “1” for the processing that is being determined in step S1406, “2” for the processing that is being determined in step S1408, and “3” for the processing that is being determined in step S1411.

Next, in step S1418, the digital camera 1110 through its control section 1205 displays a question on its display section 1206 whether to attempt to reestablish communication and waits for an input from the user; if the user indicates that he or she wishes to repeat the processing immediately, the digital camera 1110 through its control section 1205 determines the processing number T that was stored in step S1417, as shown in FIG. 18 (step S1450).

Based on the result of the determination made in step S1450, the digital camera 1110 through its control section 1205 executes the following processing: if the processing number T=1, the processing is repeated from step S1405; if the processing number T=2, the processing is repeated from step S1407; and if the processing number T=3, the processing is repeated from step S1410.

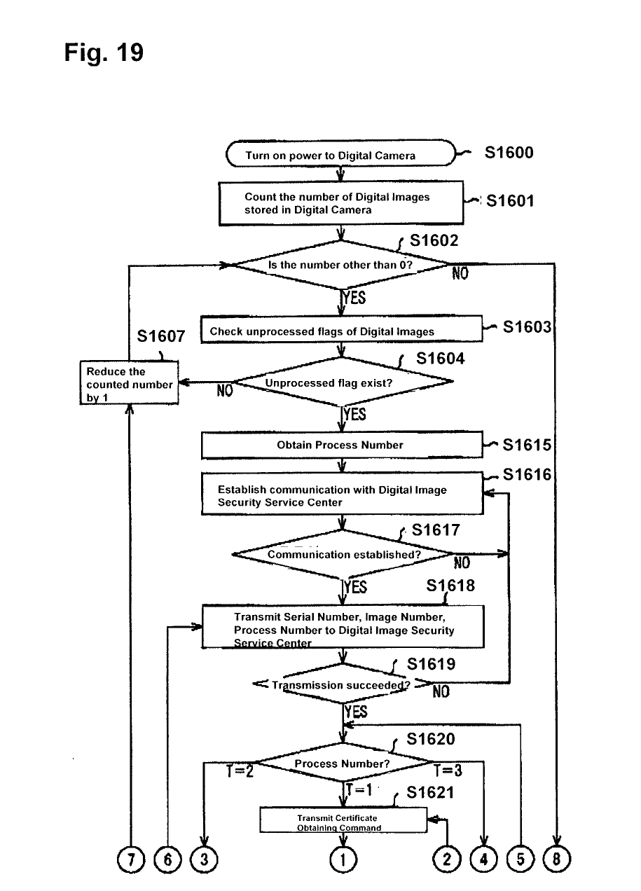

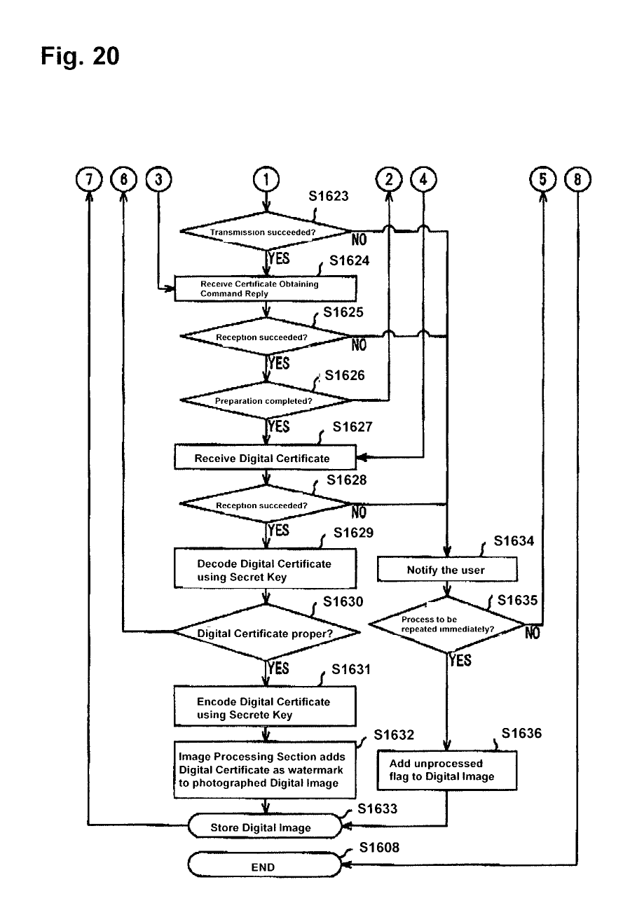

If sending or receiving information to and from the digital image security service center 1140 fails (in step S1404, step S1406, step S1408 or step S1411) and processing of the unprocessed digital image is attempted again, the repeat processing according to the present embodiment is indicated in the flowchart in FIGS. 19 and 20, for example.

The operations shown in FIGS. 19 and 20 include operations by the digital camera 1110 that take place from the time that the user presses a power source button (omitted from drawings) of the digital camera 1110 (step S1600) to the time that electronic watermark information is attached to a digital image retained in the digital camera 1110, as in FIG. 13.

First, the digital camera 1110 through its control section 1205 counts the number of digital images that are retained in the digital camera 1110 (step S1601).

Next, the digital camera 1110 through its control section 1205 judges whether the count is zero (step S1602).

If the count found as a result of step S1602 is not zero, the digital camera 1110 through its control section 1205 retrieves a digital image (step S1603), and determines whether an unprocessed flag is attached to the digital image (step S1604).

If as a result of step S1604 an unprocessed flag is found not to be attached to the digital image, the digital camera 1110 through its control section 1205 reduces the count by one (step S1607) and returns to step S1602.

On the other hand, if as a result of step S1604 an unprocessed flag is found to be attached to the digital image, the digital camera 1110 through its control section 1205 obtains the processing number T that is attached along with the unprocessed flag (step S1615).

Next, the digital camera 1110 through its control section 1205 establishes communication with the digital image security service center 1140 (step S1616).

Once it is confirmed that communication between the digital camera 1110 and the digital image security service center 1140 has been established (step S1617), the digital camera 1110 through its control section 1205 sends the serial number 1301 of the digital camera 1110, the image number and the processing number T to the digital image security service center 1140 via the network interface 1209 (step S1618).

If the transmission in step S1618 fails (step S1619), the digital camera 1110 through its control section 1205 repeats the processing from step S1616.

On the other hand, if the transmission in step S1618 is successful (step S1619), the digital camera 1110 through its control section 1205 determines the processing number T and executes the following processing: if the processing number T is “1,” the processing beginning with step S1621 is executed; if the processing number T is “2,” the processing beginning with step S1624 (see FIG. 20) is executed; and if the processing number T is “3,” the processing beginning with step S1627 (see FIG. 20) is executed.

The processing that takes place from step S1621 (see FIG. 19) to step S1636 (see FIG. 20) is similar to the processing that takes place from step S1405 to step S1419 in FIGS. 11 and 12, and the description of its detail is therefore omitted.

The digital camera 1110 through its control section 1205 stores the digital image (step S1633) and reduces the count by one (step S1607).

After this, step S1602 to step S1636 are repeated until the count is zero. Once the count becomes zero, the processing is terminated (step S1608).

<Configuration and Operations as Features of the Digital Image Security Service Center 1140 According to the Present Embodiment>

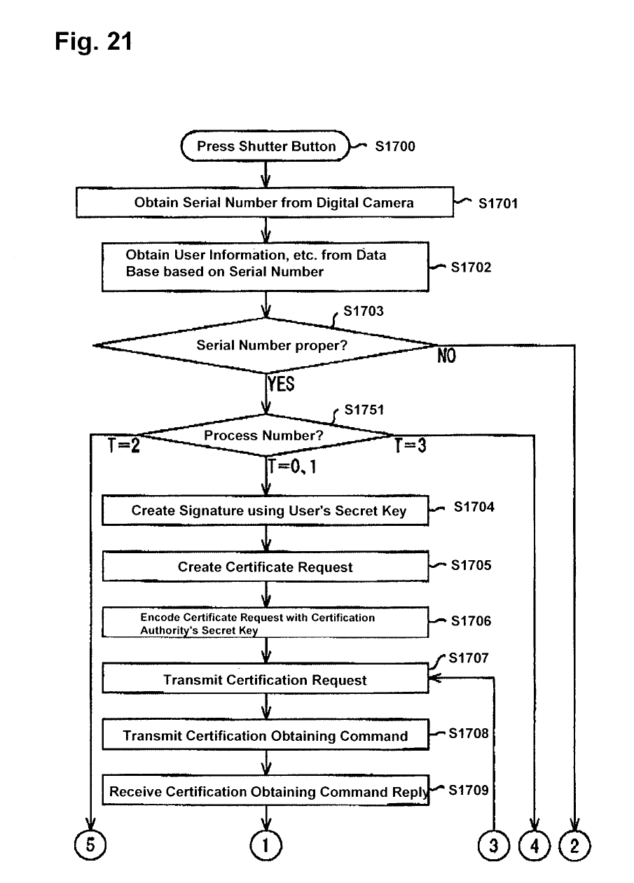

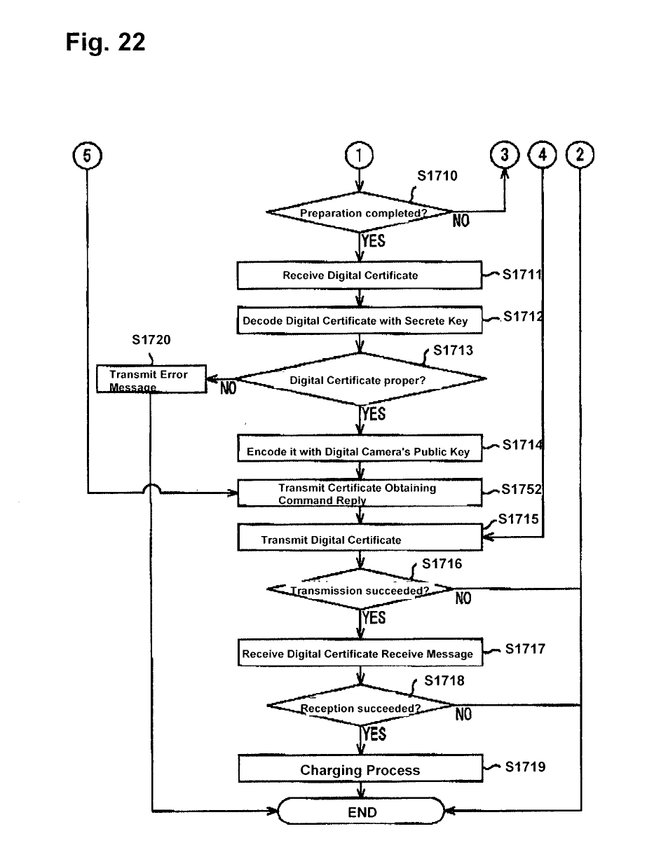

FIGS. 21 and 22 show in detail the operations of the digital image security service center 1140 according to the present embodiment.

Steps in the flowcharts in FIGS. 21 and 22 that perform processing similar to those in the flowcharts in FIGS. 14 and 15 are assigned the same numbers as in FIGS. 14 and 15 and the description of their details is omitted.

First, the digital image security service center 1140 executes the processing in step S1700-step S1703 as in the second embodiment; if it is determined in step S1703 that the serial number 1301 from the digital camera 1110 is proper information, the digital image security service center 1140 determines the processing number T that was obtained in step S1702; if the processing number T is “0” or “1,” the processing beginning with step S1704 is executed; if the processing number T is “2,” the processing beginning with step S1752 (see FIG. 22) is executed; and if the processing number T is “3,” the processing beginning with step S1715 (see FIG. 22) is executed.

If the processing number T=“2” or “3,” it signifies that the digital camera 1110 failed the preceding processing at some point and that it would resume the processing from an intermediate point.

For example, if the processing number T is “0” or “1,” the digital image security service center 1140 first creates a digital signature using a secret key of the digital camera 1110 that was obtained in step S1702, as in the second embodiment (step S1704), and executes the processing that follows in step S1705-step S1714 (see FIG. 22).

Next, the digital image security service center 1140 sends a certificate obtaining command reply in order to notify the digital camera 1110 of the completion of preparations to obtain a certificate (step S1752).

The digital image security service center 1140 executes the processing from step S1715, as in the second embodiment.

Due to the fact that processing does not have to be repeated from the beginning according to the present embodiment, repeat processing can be done more quickly. Repeating the processing too long can cause the user to miss a photo opportunity, and for this reason this feature is useful in devices such as camera that require immediate response.

In the present embodiment, the digital image security service center 1140 and the certification authority 1130 were described as separate devices (terminals), but the digital image security service center 1140 and the certification authority 1130 may be combined.

Even if the digital image security service center 1140 and the certification center 1130 were separate devices (terminals), the service to issue certificates can be considered to be provided by the digital image security service center 1140 and the certification authority 1130 acting as one.

In this case, needless to say, the communication between the digital image security service center 1140 and the certification authority 1130 can be omitted.

However, a configuration in which the digital image security service center 1140 and the certification authority 1130 are separate terminals as in the present embodiment is convenient when one service center 1140 communicates with a plurality of certification authorities 1130.

Needless to say, the purpose of the present invention can be achieved by providing in a system or a device a storage medium that stores program codes of software that realize the functions of the host computer and terminals according to the first through third embodiments, and having a computer (or a CPU or an MPU) of the system or the device read and execute the program codes stored in the storage medium.

In this case, the program codes themselves that are read from the storage medium realize the functions of the first through third embodiments, and the storage medium that stores the program codes and the program codes themselves constitute the present invention.

The storage medium on which to supply the program codes may be a ROM, a flexible disk, a hard disk, an optical disk, an optical magnetic disk, a CD-ROM, a CD-R, a magnetic tape, or a nonvolatile memory card.

Furthermore, it goes without saying that the present invention is applicable not only when the program codes read by a computer are executed to realize the functions of the first through third embodiments, but also when an operating system that operates on the computer performs a part or all of the actual processing based on the instructions contained in the program codes and thereby realizes the functions of the first through third embodiments.

Moreover, needless to say, the present invention is also applicable when the program codes that are read from the storage medium are written onto an expansion board inserted into a computer or on a memory of an expansion unit connected to a computer, and a CPU provided on the expansion board or the expansion unit performs a part or all of the actual processing based on the instructions contained in the program codes and thereby realizes the functions of the first through third embodiments.

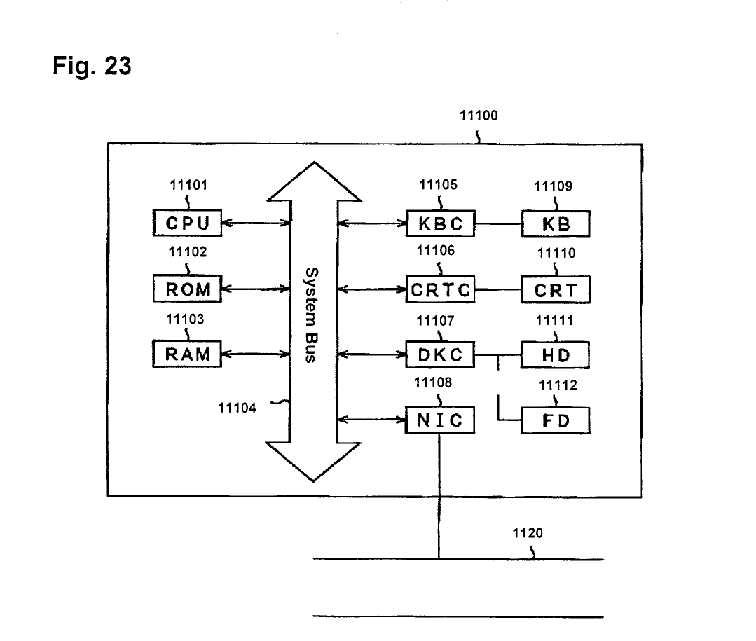

FIG. 23 shows one example of a computer function 11100 described above.

The computer function 11100 comprises, as shown in FIG. 23, a CPU 11101, a ROM 11102, a RAM 11103, a keyboard controller (KBC) 11105 of a keyboard (KB) 11109, a CRT controller (CRTC) 11106 of a CRT display (CRT) 11110 that is a display section, a disk controller (DKC) 11107 of a hard disk (HD) 11111 and a flexible disk (FD) 11112, and a network interface card (NIC) 11108 for communication via the network 1120, where each of the elements is connected communicatively with each other via a system bus 11104.

The CPU 11101 consolidates the control of various components connected to the system bus 11104 by executing software stored in the ROM 11102 or the HD 11111, or software provided by the FD 11112.

In other words, the CPU 11101 performs controls to realize the operations of the first through third embodiments described above by reading and executing from the ROM 11102, the HD 11111 or the FD 11112 processing programs that follow a predetermined processing sequence.

The RAM 11103 functions as a primary memory or work area for the CPU 11101.

The KBC 11105 controls input of instructions from the KB 11109 or pointing devices omitted from drawings.

The CRTC 11106 controls displays on the CRT 11110.

The DKC 11107 controls access to the HD 11111 and the FD 11112 that store a boot program, various applications, editing files, user files, network management programs, and predetermined processing programs.

The NIC 11108 exchanges data bidirectionally with devices or systems on the network 1120.

As described above, when a body (e.g., a digital camera) that obtains digital information of one's choice (e.g., digital images obtained by photographing with a digital camera) requests to, and obtains from, a predetermined organization (e.g., a reliable, public, third party organization) via any means of communication (e.g., a network) a digital certificate for the digital information, the body does so through an agent organization that participates in the communication means and that requests for and obtains the digital certificate. In other words, the agent organization reliably requests and obtains a digital certificate for the digital information in place of the body that obtained the digital information.

Through this, the body obtaining the digital information can use the highly reliable digital certificate as information to prove the admissibility of any digital information, and the processing burden on the body obtaining the digital information can be reduced.

Specifically, for example, when photographing with a digital camera, the digital camera sends a serial number unique to the digital camera to an agent organization (e.g., the digital image security service center). Upon receiving the serial number, the agent organization extracts information that corresponds to the serial number from management information (e.g., a secret key and a public key of the digital camera, user information, charging information) and uses the extracted information to request a certification authority (e.g., a predetermined organization) to issue a digital certificate, and sends the digital certificate obtained thereby to the digital camera. The digital camera embeds the digital certificate from the agent organization as electronic watermark information in a photographed image (e.g., a digital image). In consideration of situations in which the communication means is unstable and a series of processing by the system is interrupted, a processing to repeat and resume processing from where the processing was interrupted can be realized.

As a result, the processing burden on the digital camera can be reduced and the digital image can be securely protected from any alterations. Further, even if the digital image were to be deliberately altered, due to the fact that the electronic watermark information (i.e., the digital certificate issued by the certification authority) attached to the digital image could not be restored, an unrestored digital certificate becomes a proof that the digital image has been altered. Moreover, due to the fact that the electronic watermark information attached to the digital image is the digital certificate issued by the certification authority, the uniqueness of the digital image to which the digital certificate is attached can be ensured.

As a result, according to the present invention, the processing burden on the body obtaining the digital information can be reduced and digital information that is unalterable, reliable and has high admissibility can be provided.

In addition, in situations in which a digital certificate could not be obtained, an attempt to obtain the certificate can be repeated while alterations are prevented from being made. Further, since the image data is stored in a storage medium in such a situation, the data can be protected.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An information processing apparatus that exchanges digital information with an external device via a communication device, the information processing apparatus comprising:
an information obtaining module that obtains digital information;
a certification obtaining module that requests a certification issuing authority that issues a digital certification for a given digital information to issue the digital certification, and obtains the digital certification via the communication device; and
a storage control module that correlates the digital certification obtained to the digital information obtained by the information obtaining module and stores the digital certification in a storage medium.

2. An information processing apparatus according to claim 1, wherein the information obtaining module executes an obtaining process, and the certification obtaining module requests the digital certification in association with the obtaining process.

3. An information processing apparatus according to claim 1, further comprising a re-execution control module that, when the certification obtaining module cannot obtain a digital certification, stores digital information obtained by the information obtaining module in the storage medium without obtaining the digital certification, controls an execution of a next obtaining process to obtain information by the information obtaining module, and controls to repeat an obtaining process to obtain the digital certification.

4. An information processing apparatus according to claim 3, wherein, when an obtaining process to obtain the digital certification is completed midway, the re-execution control module stores information concerning the obtaining process up to a point at which the obtaining process terminates midway, and executes an obtaining process again to obtain the digital certification based on the information stored.

5. An information processing apparatus according to claim 4, further comprising a modification prohibition module that, when the certification obtaining module cannot obtain a digital certification, stores digital information obtained by the information obtaining module in the storage medium without obtaining the digital certification, and prohibits any modification on the digital information stored in the storage medium without a digital certification having been obtained.

6. An information processing apparatus according to claim 1, wherein the information obtaining module is a photographing device.

7. An information processing apparatus that exchanges digital information with an external device via a communication device, the information processing apparatus comprising:
an obtaining module that requests a certification issuing authority that issues a digital certification for a given digital information through an agent organization that performs an obtaining process to obtain the digital certification as an agent to issue the digital certification, and obtains the digital certification via the communication device.

8. An information processing apparatus according to claim 7, further comprising an image obtaining module that obtains digital image data as the given digital information.

9. An information processing apparatus according to claim 8, wherein the image obtaining module includes a digital camera function.

10. An information processing apparatus according to claim 7, wherein the obtaining module provides the agent organization that manages information required for an obtaining process to obtain the digital certification with information unique to identify the obtaining module, thereby requesting the certification issuing authority through the agent organization to issue the digital certification.

11. An information processing apparatus according to claim 7, wherein the obtaining module requests the digital certification through the agent organization using a certification request with a public key generated by the obtaining module added thereto.

12. An information processing apparatus according to claim 7, wherein the obtaining module confirms if the digital certification is legitimate.

13. An information processing apparatus according to claim 7, wherein the obtaining module encodes the digital certification with a secret key that is generated by the obtaining module.

14. An information processing apparatus according to claim 7, further comprising an electronic watermark processing module that adds the digital certification obtained by the obtaining module as electronic watermark information to the given digital information.

15. An information processing apparatus that exchanges digital information with an external device via a communication device, the information processing apparatus comprising:
a receiving module that receives an issue request to issue a digital certification from a digital information obtaining side that obtains the digital information; and
a providing module that requests via the communication device a certification issuing authority that issues a digital certification for a given digital information based on the issue request received by the receiving module to issue the digital certification, and provides the digital information obtaining side with the digital certification obtained from the certification issuing authority.

16. An information processing apparatus according to claim 15, further comprising a management module that manages information to identify the digital information obtaining side, wherein the providing module requests the digital certification based on the information managed by the management module upon identifying the digital information obtaining side.

17. An information processing apparatus according to claim 15, further comprising a module that manages charge information for the digital information obtaining side that is identified by the management module.

18. An information processing method using an information processing apparatus that exchanges digital information with an external device via a communication device, the information processing method comprising:
an information obtaining step of obtaining digital information;
a certification obtaining step of requesting a certification issuing authority that issues a digital certification for a given digital information to issue the digital certification, and obtaining the digital certification via the communication device; and
a storage control step of correlating the digital certification obtained to the digital information obtained by the information obtaining step and storing the digital certification in a storage medium.

19. An information processing method according to claim 18, wherein the information obtaining step executes an obtaining process, and the certification obtaining step requests the digital certification in association with the obtaining process.

20. An information processing method according to claim 18, further comprising a re-execution control step of, when the certification obtaining step cannot obtain a digital certification, storing digital information obtained by the information obtaining step in the storage medium without obtaining the digital certification, controlling an execution of a next obtaining process to obtain information by the information obtaining step, and controlling to repeat an obtaining process to obtain the digital certification.

21. An information processing method according to claim 20, wherein, when an obtaining process to obtain the digital certification is completed midway, the re-execution control step stores information concerning the obtaining process up to a point at which the obtaining process terminates midway, and executes an obtaining process again to obtain the digital certification based on the information stored.

22. An information processing method according to claim 18, further comprising a modification prohibition step of, when the certification obtaining step cannot obtain a digital certification, storing digital information obtained by the information obtaining step in the storage medium without obtaining the digital certification, and prohibiting any modification on the digital information stored in the storage medium without a digital certification having been obtained.

23. An information processing method according to claim 18, wherein the information obtaining step is executed in response to a photographing direction.

24. A digital information securing method that secures a given digital information, the digital information securing method comprising:
a processing step conducted by an obtaining side that obtains the given digital information of requesting a certification issuing authority that issues a digital certification for the given digital information through an agent organization that performs an obtaining process to obtain the digital certification as an agent to issue the digital certification, and obtaining the digital certification via the communication device.

25. A digital information securing method according to claim 24, wherein the processing step comprises:
a step performed by the obtaining side of transmitting identification information unique to the obtaining side that obtains the given digital information to the agent organization;
a step performed by the agent organization of requesting the certification issuing authority to issue the digital certification based on the identification information and obtaining the digital certification; and
a step performed by the agent organization of providing the digital certification obtained from the certification issuing authority to the obtaining side.

26. A storage medium that stores a program for executing the information processing method using an information processing apparatus that exchanges digital information with an external device via a communication device, the information processing method comprising:
an information obtaining step of obtaining digital information;
a certification obtaining step of requesting a certification issuing authority that issues a digital certification for a given digital information to issue the digital certification, and obtaining the digital certification via the communication device; and
a storage control step of correlating the digital certification obtained to the digital information obtained by the information obtaining step and storing the digital certification in a storage medium.

27. A storage medium that stores a program for storing digital information securing method that secures a given digital information, the digital information securing method comprising:
a processing step conducted by an obtaining side that obtains the given digital information of requesting a certification issuing authority that issues a digital certification for the given digital information through an agent organization that performs an obtaining process to obtain the digital certification as an agent to issue the digital certification, and obtaining the digital certification via the communication device.

28. A program for executing the information processing method using an information processing apparatus that exchanges digital information with an external device via a communication device, the information processing method comprising:
an information obtaining step of obtaining digital information;
a certification obtaining step of requesting a certification issuing authority that issues a digital certification for a given digital information to issue the digital certification, and obtaining the digital certification via the communication device; and
a storage control step of correlating the digital certification obtained to the digital information obtained by the information obtaining step and storing the digital certification in a storage medium.

29. A program for storing digital information securing method that secures a given digital information, the digital information securing method comprising:
a processing step conducted by an obtaining side that obtains the given digital information of requesting a certification issuing authority that issues a digital certification for the given digital information through an agent organization that performs an obtaining process to obtain the digital certification as an agent to issue the digital certification, and obtaining the digital certification via the communication device.
